(19) United States
(12) Patent Application Publication
(10) Pub. No.: US 2007/0297106 A1
(43) Pub. Date: Dec. 27, 2007

(54) ESD AND ELECTRIC SURGE PROTECTED CIRCUIT AND METHOD OF MAKING SAME

(76) Inventors: Peter H. Dai, La Canada, CA (US); Jane Xu, Thousand Oaks, CA (US); Peter J. Zampardi, Newbury Park, CA (US); Ravi Ramanathan, Thousand Oaks, CA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/426,075

(22) Filed: Jun. 23, 2006

(51) Int. Cl. H02H 9/00

(52) U.S. Cl. 361/56

(57) ABSTRACT

A circuit and process is provided for protecting a device from the detrimental effects of electro-static discharge (ESD). The circuit includes an ESD breakdown device that is used to activate a current drawdown device. When a voltage exceeding the ESD breakdown device's breakdown voltage is applied, a signal is generated that causes the current drawdown device to pump current to ground. In this way, the effects of the ESD charge are substantially reduced. In one example, the ESD breakdown device is a reverse biased diode, and the current drawdown circuit includes a Darlington circuit. When an ESD surge causes the diode to breakdown, a signal is applied to the Darlington circuit, which pumps the ESD current safely to ground.

### BACKGROUND

The field of the present invention is the design, fabrication, manufacture and use of ESD (Electro-Static Discharge) circuits. More particularly, the invention relates to an integrated circuit employing an ESD protection circuit for protecting a sensitive electronic component.

Electric static discharge (ESD) is a serious problem for many modern electronic devices. ESDs are undesirable voltages and currents generated during the manufacturing process or during use that may destroy or damage sensitive electronic equipment or components. For example, a human may transfer static electricity to a device, thereby sending hundreds, if not thousands, of damaging volts into highly sensitive transistors, integrated circuits, and memory devices. To avoid such damaging and fatal consequences, circuits are often designed with ESD protection circuits. In one example, a power transistor for a wireless device has an ESD protection circuit that allows the power transistor to operate in its normal and expected voltage ranges, while shunting damaging ESD power to ground.

Electric surge is short time event in which an undesirable high voltage spike is applied to the electronic device due to poor quality of power supply, or due to improperly operation of the device. Such voltage spikes can damage the device. In this discussion, ESD or ESD signal is commonly used to refer to both ESD and to electric surge saturations for simplicity.

FIG. 9 shows device P1 having a power transistor a. Power transistor a generates an output signal on line b, which may be used to radiate an RF signal on an antenna. At the same time, line b is also electrically connected to power supply providing dc biasing to power transistor a. Since transistor a is a power transistor, it has expected voltage swings of about 0 volts to about 10 volts. Accordingly, any voltage between 0 and 10 should not activate the ESD protection mechanism, and the RF signal should be allowed to radiate normally. To accommodate this desired result, a first set d and a second set e of serial diodes cooperate to shunt higher voltage ESD signals to ground. Each diode has a forward bias of about 1.2 volts, and each set of diodes has 10 diodes. In this way, when the voltage on line b exceeds about 12 V, current will flow as shown by lines g. Two sets of diodes are used to more efficiently pass current from line b to ground. In this way, with the voltage drop across diode sets as shown by line f exceeds about 12 V, current will be drained from signal line b to ground, thereby protecting device a. Since the expected operational signals on line b are to be between about 0 volts and 10 volts, any negative voltage less than negative 1.2V on line b will be immediately shunted to ground through line h. Accordingly, line f is positioned and arranged to shunt all higher than specified positive voltages immediately to ground, and line h is positioned and arranged to shunt all less than −1.2V negative voltage immediately to ground.

Although ESD circuit c offers some protection for device a, the sets of diodes are relatively inefficient and slow in passing current. Accordingly, some damaging power may get to device a. Also, the diode sets and supporting circuitry consume a large area of integrated circuit space. For example, a typical ESD protection device as illustrated in P1 may consume about 22,000 to about 25,000 μm². To reduce the amount of space needed for the ESD protection circuit, another ESD circuit has been proposed.

FIG. 10 shows ESD circuit P2 having a transistor z outputting a signal onto low impedance signal line y. It will be appreciated that the impedance should be properly matched between the rf transistor and its load. The ESD protection circuit x has a set of eight forward biased diodes as shown by set v. The set of diodes w therefore require a voltage drop of about 9.6 voltages before voltage begins to build at the activation input for the Darlington circuit t. When the voltage at the input to the Darlington circuit t reaches about 1.2 V, then diode r becomes forward biased, and current will begin flowing through resistor q to ground. Resistor q is selected so that the forward bias voltage of diode r, when added to the voltage drop across resistor q, generates a sufficient activation voltage for the Darlington circuit t. Typically, the activation voltage will be in the range of about 2 V to 3 V. When the Darlington circuit t activates, it acts to pump current from signal line y to ground as shown by line s. In this way, current and damaging ESD power is more quickly and efficiently removed from line y. Also, because this circuit construction has fewer diodes, it may be implemented in less space than the device P1 shown with reference to FIG. 9.

However, device P2 still consumes considerable real estate on the integrated circuit, and still requires that eight serial diodes activate prior to triggering the ESD protection circuit. Accordingly, there exists a need for an ESD protection circuit that consumes less real estate on the integrated circuit, while more efficiently and effectively removing power from the output line.

### SUMMARY

Briefly, the present invention provides a circuit and process for protecting a device from the detrimental effects of electro-static discharge (ESD). The circuit includes an ESD breakdown device that is used to activate a current drawdown device. When a voltage exceeding the ESD breakdown device's breakdown voltage is applied, a signal is generated that causes the current drawdown device to pump current to ground. In this way, the effects of the ESD charge are substantially reduced. In one example, the ESD breakdown device is a reverse biased diode, and the current drawdown circuit includes a Darlington circuit. When an ESD surge causes the diode to breakdown, a signal is applied to the Darlington circuit, which pumps the ESD current safely to ground.

Advantageously, the disclosed ESD protection circuit may be implemented in less area than known protection circuits, while effectively and efficiently protecting a device from damaging ESD spikes.

### BRIEF DESCRIPTION OF THE DRAWINGS

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views. It will also be understood that certain components and details may not appear in the figures to assist in more clearly describing the invention.

FIG. 1 is a block diagram of an ESD protected device in accordance with the present invention.

FIG. 2 is a block diagram of an ESD protected power amplifier in accordance with the present invention.

FIG. 3 is a block diagram of an ESD protected device in accordance with the present invention.

FIG. 4a is a block diagram of an ESD protected power amplifier in accordance with the present invention

FIG. 4b is a diagram of typical output line voltages for of an ESD protected power amplifier in accordance with the present invention.

FIG. 5 is a circuit diagram of an ESD protected power transistor in accordance with the present invention

FIG. 6 is a flowchart of a method for making an ESD protected device in accordance with the present invention.

FIG. 7 is a flowchart of a method for using an ESD protected device in accordance with the present invention.

FIG. 8 is a circuit diagram of an ESD protected power transistor in accordance with the present invention when higher voltage swing headroom of RF signal is required.

FIG. 9 is a circuit diagram of a prior art ESD protected power transistor.

FIG. 10 is a circuit diagram of a prior art ESD protected power transistor.

### DETAILED DESCRIPTION

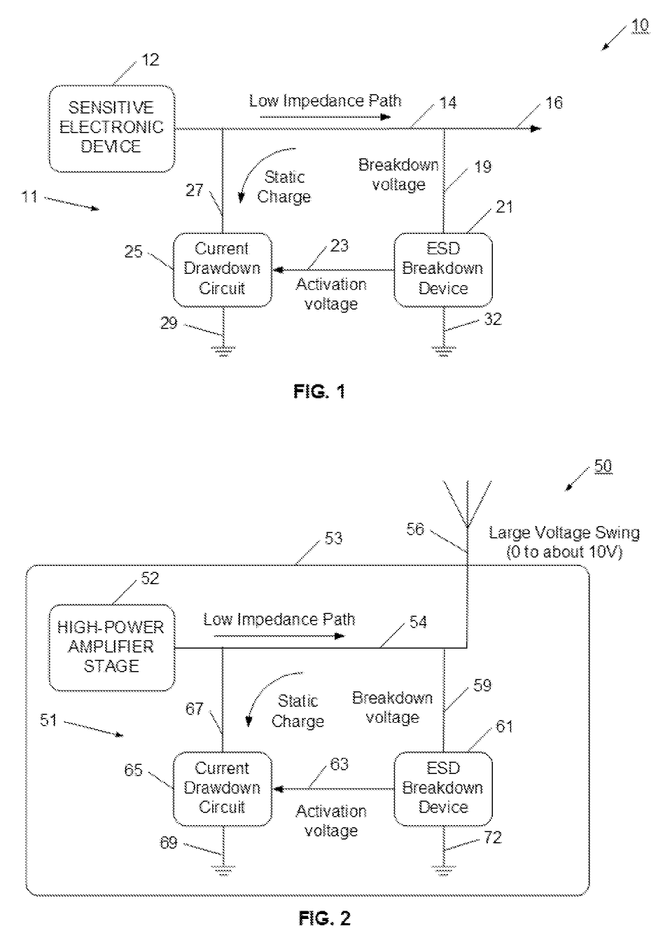

Referring now to FIG. 1, an ESD protected device 10 is illustrated. Electrostatic discharge (ESD) is a serious problem for many sensitive electronic devices. For example, transistors, integrated circuits, and memory devices are all sensitive to electrostatic discharge signals. Such ESD signals can reach hundreds or even thousands of volts, and can destroy circuitry or detrimentally affect circuit operations. Device 10 has a sensitive electronic device 12, such as a transistor device. The sensitive electronic device 12 has an signal line 14 that creates a low impedance path to an output 16. When no ESD signal is present, the low impedance path acts as a simple output line for the sensitive electronic device 12. However, from time to time, an electrostatic charge may be applied at the output 16 or at some other point on signal line 14. If this ESD signal is allowed to reach the sensitive electronic device 12, the ESD signal may destroy or render the device 12 inoperable. Accordingly, an ESD protection circuit 11 is provided.

ESD protection circuit 11 has an ESD breakdown device 21 connected to the signal line 14. When an ESD signal is applied to signal line 14, the ESD signal is transmitted to the ESD breakdown device 21 through connection line 19. ESD breakdown device 21 may be, for example, a diode or other semiconducting device. In another example, ESD breakdown device 21 is a transistor or other PN or NP junction device. When ESD breakdown device 21 has a sufficiently high voltage on line 19, a small amount of current flows through the ESD breakdown device to ground 32. The flow of current creates an activation voltage which appears on trigger line 23. Trigger line 23 is connected to a current drawdown circuit 25. Current drawdown circuit 25 is also connected to the signal line 14 by high-gain current path 27. When not triggered, both the ESD breakdown device and the current drawdown circuit have a very high impedance, or appears as an open circuit, to the signal line 14. In this way, when the current drawdown circuit 25 is not activated, no or only an insignificant amount of the signal from the device 12 passes into current drawdown circuit 25 and ESD breakdown device 21.

However, upon receiving the required activation signal on trigger line 23, the current drawdown circuit 25 reacts to pump current from signal line 14 to ground 29. In this way, any excess current, including current generated responsive to the ESD signal or voltage spike, is pumped to ground. Since the current is pumped to ground, it is not able to damage the sensitive electronic device 12. After the ESD current has been pumped to the ground, the signal line 14 returns to its normal operational voltage, causing the ESD breakdown device to stop passing current. Accordingly, the activation voltage is removed from the trigger line 23, and the current drawdown circuit 25 stops pumping current. In this normal state, the sensitive electronic device 12 is allowed to normally pass its output signal through the low impedance output path 14. Advantageously, the ESD protection circuit is implemented in an area smaller than known circuits, and quickly and efficiently reacts to an ESD signal.

Referring now to FIG. 2, an ESD protected device 50 is illustrated. ESD protected device 50 is a power amplifier integrated circuit 53 having a high power amplifier stage 52 coupled to an ESD protection circuit 51. As illustrated, the high power amplifier stage 52 may be a final stage power amplifier for a wireless radio system. Accordingly, the low impedance output path 54 requires a relatively large voltage swing, for example from about 0 volts to about 10 volts. It will be appreciated that other types of operational voltage requirements may be required for other types of power amplifiers. During normal operation, the high power amplifier stage provides an RF signal on low impedance signal path 54 which is radiated through antenna 56. The RF signal typically has a maximum voltage of about 10 volts. During this normal operation, the ESD protection circuit 51 is not significantly affecting the low impedance path 54, and appears substantially as an open circuit. However, upon the application of an electrostatic discharge signal or electric surge to antenna 56 or to the low impedance path 54, the ESD protection circuit 51 acts to protect the high power amplifier stage 52 from destruction.

Typically, a high-power amplifier stage 52 has a breakdown voltage of about 14 volts. Accordingly, any voltage over about 14 volts on the signal line 54 will induce current flow from the signal line 54 through the amplifier stage 52 and into preceding circuitry, and may permanently destroyed or alter the performance of the high power amplifier stage 52 and its associated amplification circuitries. In this way, the ESD protection circuit 51 is configured so that it reacts to signals larger than the operational voltage swings, but smaller than the damaging voltage at which the high-power amplifier stage 52 would be damaged. In the illustrated construction, the desired trigger voltage for the ESD protection circuit 51 therefore is in the range between about 10 volts and about 14 volts. It will be appreciated that the ESD trigger voltage would be adjusted according to specific power amplifier characteristics and required operational voltage swings.

For device 50, when an ESD voltage or signal is on signal path 54, and the voltage exceeds the defined ESD trigger voltage, an ESD breakdown device 61 begins to pass current to ground 72. In one example, the ESD breakdown device may be one or more diodes, where at least one of the diodes is arranged reverse biased and counter to the expected flow of current on line 59. In this way, the voltages across the diodes, including the reverse biased diode, cooperate to assist in setting the ESD trigger voltage. Once the ESD trigger voltage has been met, an activation voltage appears on drawdown trigger line 63, which activates the current drawdown circuit 65. Upon activation, the current drawdown circuit 65 pumps current from the signal line 54 through line 67 to ground 69. Accordingly, current induced by the ESD signal is quickly drawn or pumped to ground. In this way, the ESD signal's power is not able to damage the high-power amplifier stage 52. Advantageously, the ESD protection circuit is implemented in an area smaller than known circuits, and quickly and efficiently reacts to an ESD signal.

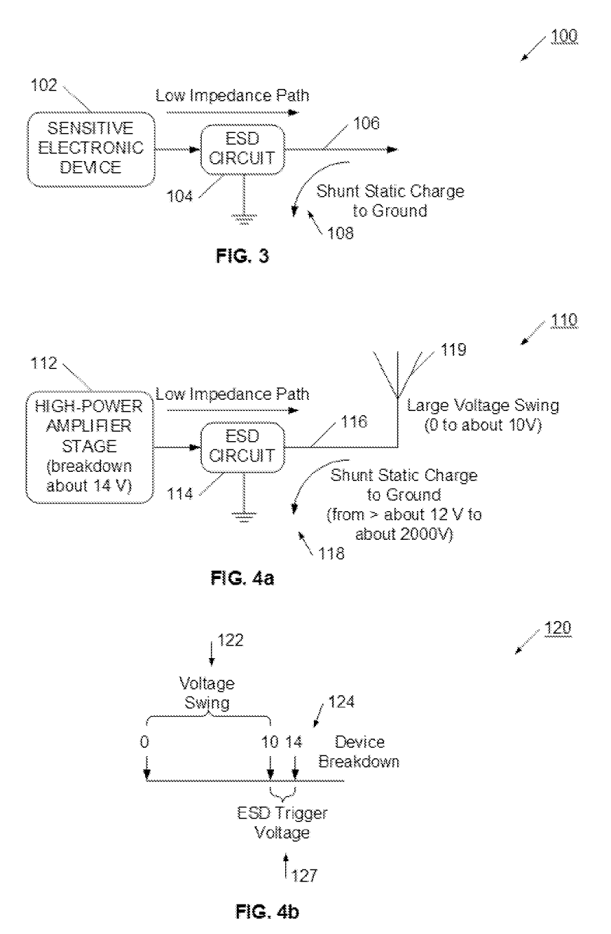

Referring now to FIG. 3, a more general view of an ESD protected device 100 is illustrated. ESD protected device 100 may be, for example, a power amplifier, a transistor, or memory circuit. The protected device 100 has a sensitive electronic device 102, such as a transistor or other semiconductor device. The sensitive electronic device 102 has a signal line that is received into an ESD protection circuit 104. The ESD protection circuit 104 allows a low impedance path 106 to an input and output port or other type of port, such as power supplies, etc, when no ESD signal is present. However, when an ESD signal is presented on line 106, the ESD power is pumped to ground as shown by line 108. In this way, the sensitive electronic device 102 is able to generate a normal output on line 106 when no ESD signal is present, but upon having an ESD event or signal, the current on line 106 is pumped to ground. This prevents damage to the sensitive electronic device 102 or its associated circuits.

Referring now to FIG. 4a, a more specific ESD protected device 110 is illustrated. Device 110 has a high-power amplifier stage 112 with a breakdown voltage of about 14 volts. A high-power amplifier stage 112 may be, for example, part of a final amplification stage for a wireless device. The high-power amplifier stage 112 has an RF low impedance path 116 for radiating RF energy through antenna 119. In many cases, the RF low impedance path 116 also electrically connected to DC power supply before the RF output coupler component. In one example, the RF energy has a voltage swing of about 0 to about 10 volts. ESD protection circuit 114 is constructed to allow the high-power amplifier stage 112 to radiate RF energy through the low impedance path and to provide low resistance path for the device DC current when no ESD event or signal is detected. However, upon the presence of an ESD event or signal at antenna 119 or on line 116, the ESD current is pumped to ground as shown by line 118. For a typical high-power amplifier 112, the ESD circuit 114 is constructed to pump current when an ESD voltage greater than about 12 volts appears on line 116, and is able to safely and effectively pump current up to specified ESD level, such as above about an ESD of 2000 volts. It will be appreciated that other circuit implementations and circuit components may be selected when more than 2000 V of protection is needed.

Referring now to FIG. 4b, a graph of output line voltages is illustrated. Graph 120 shows that an output line is normally expected to operate with voltage swing 122. In the case of a high-power amplifier stage, the voltage swing may typically be in the range of about 0 to about 10 volts as illustrated. Also, a high-power amplifier stage 112 typically has a breakdown voltage of about 14 volts as shown at line 124. In this way, damaging voltages above 14 volts on the output line may act to destroy or detrimentally affect performance of the high-power amplifier. Since the output voltage is expected to be in the voltage swing 122, and damage may occur above the device breakdown voltage 124, the ESD protection circuit should activate within the ESD trigger voltage range 127. For a typical high-power amplifier stage in mobile handset application, this trigger voltage may be in the range between about 10 volts and about 14 volts. It will be appreciated that other voltage swings and device breakdowns may require other ESD trigger voltages. Typically, it is desirable to have some safety margin below the damaging breakdown voltage, and is desirable to have the ESD trigger voltage set at least a little above the highest expected voltage swing. Accordingly, a trigger voltage at around 11 volts may be desirable for a high power amplifier stage 112. It will be appreciated that specific ESD trigger voltages may be dependent on application-specific requirements, and the specific components used.

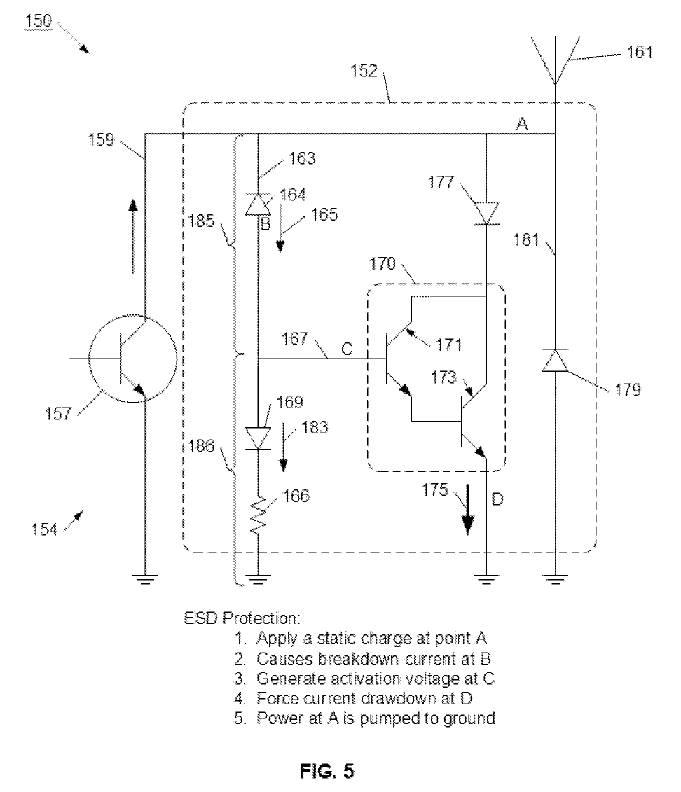

Referring now to FIG. 5, a specific ESD protected device 150 is illustrated. ESD protected device 150 is a portion of a high power amplifier stage for a wireless radio. The device 150 has a power transistor 157 for amplifying a radio signal to be output on signal line 159. The RF signal on line 159 may then be radiated through antenna 161. During normal operation, the transistor 157 acts to radiate the RF signal through the low impedance line 159 and the antenna 161, and DC power supply will provide DC power to transistor 157 through 159. In such normal operation the ESD protection circuit 154 does not substantially affect circuit performance. However, an ESD signal or event may occur which places a damaging voltage at the antenna 161 or on line 159. This may occur, for example, during the manufacturing process, or may occur during routine use of the end product.

If the applied ESD voltage or signal is greater than the breakdown voltage for transistor 157, permanent damage may occur to transistor 157 or its associated circuitry. The ESD voltage or signal may be applied at point A of FIG. 5, which causes a similar voltage to be applied at point 163 of diode 164. Diode 164 has been reverse biased and is positioned counter to expected current flow, so will block current flow below its breakdown voltage. The diode may be selected such that its breakdown voltage is at about 9 volts. In this way, when the voltage at point 163 exceeds the breakdown voltage of about 9 volts, a voltage will build at point B. If the voltage at point 163 is only somewhat higher than 9 volts, the voltage level at B will not rise sufficiently to provide an activation voltage for the drawdown circuit 170. More specifically, the voltage on line 167 would not reach the necessary 2 to 3 volts to activate cascaded transistors 171 and 173.

However, if the ESD voltage at point 163 is higher, say for example, 15 volts, then the voltage at point B will continue to rise until it reaches the forward bias voltage for diode at 169. Typically, the forward bias voltage for diode 169 will be about 1.2 V. In this way, at 1.2 volts current 183 begins to flow through diode 169 and through resistor 166 to ground. The size of resistor 166 is selected such that the voltage drop across the resistance 166 added to the 1.2 volts across diode 169 provides a sufficient voltage on line 167 to turn on transistors 171 and 173. Typically, voltage 167 will need to be in the range of about 2 to 3 volts (2.5V will be a typically value) to activate the transistors and any other components in the Darlington circuit.

Transistor 171 is one driver component to transistor 173 in the current drawdown circuit 170, and transistor 173 is the main current drawdown component in the circuit 170. The size of 173 should be selected to safely pass the high current from ESD or electric surge for short period of time. Current drawdown circuit 170 is constructed as a Darlington circuit. A Darlington circuit is well known as a current drawdown device, and is able to generate current gains of about 10,000 or more. In this way, a very small current on line 167 may cause a very large current flow 175. More specifically, current 167 is used to activate transistor 171, which amplifies current on line 167. Once activated, the amplified signal from transistor 171 is received at the base of transistor 173, where it is again amplified. Depending upon the specific characteristics and gains of transistors 171 and 173, a very substantial amplification may be realized from input 167 to current output 175 for the Darlington device 170. Accordingly, when the Darlington device 170 is activated, it acts as a current pump to drain current from point A, through diode 177, and into ground as shown in line 175. Accordingly, any current generated by an ESD signal is shunted or drawn to ground. Although a Darlington circuit is illustrated, it will be appreciated that other high-current-gain circuits or cascaded transistors may be used. The diode 177 may be selected to have high current handling capability to pass high ESD current safely. The diode 177 is inserted between point A and Darlington device 170 for the purpose of reducing RF load to transistor 157 in normal RF operation.

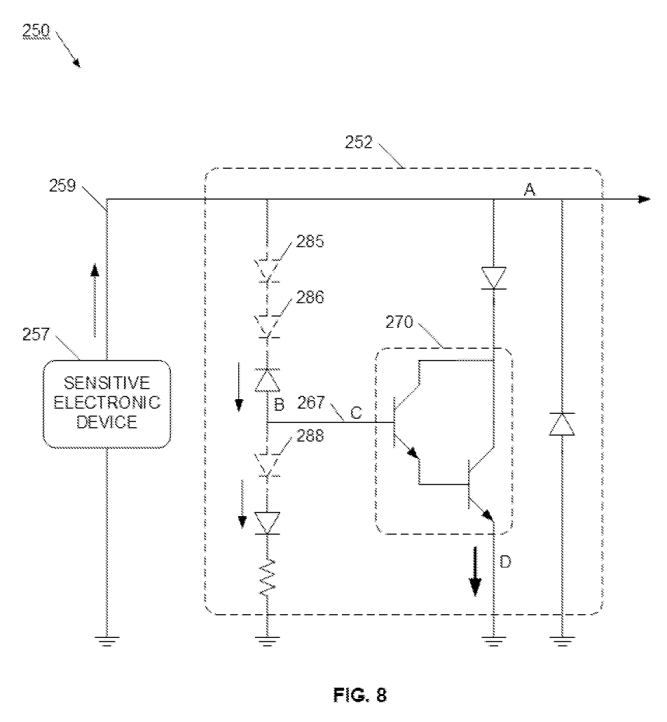

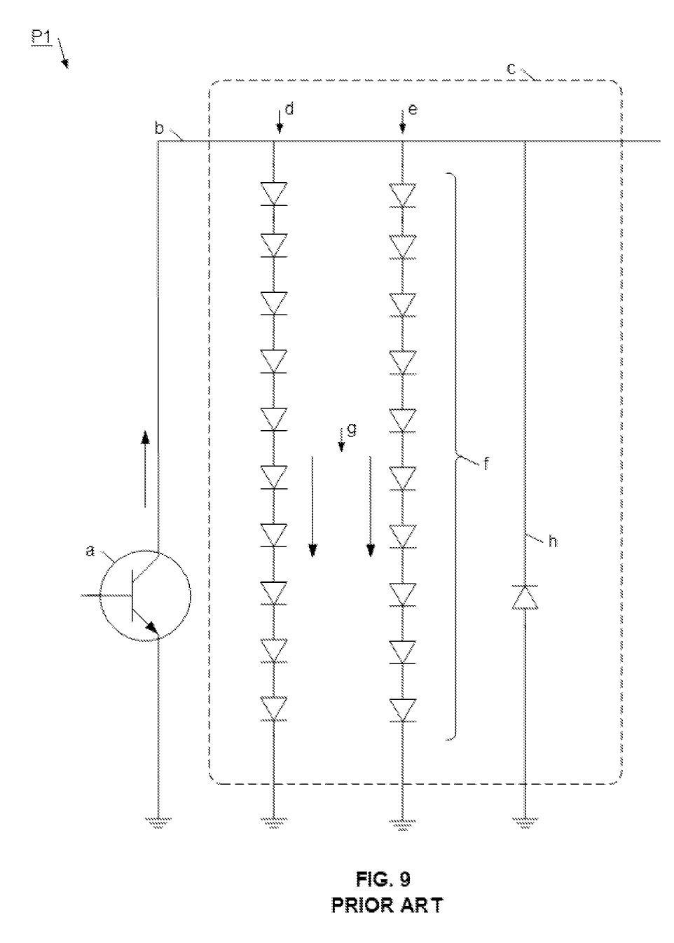

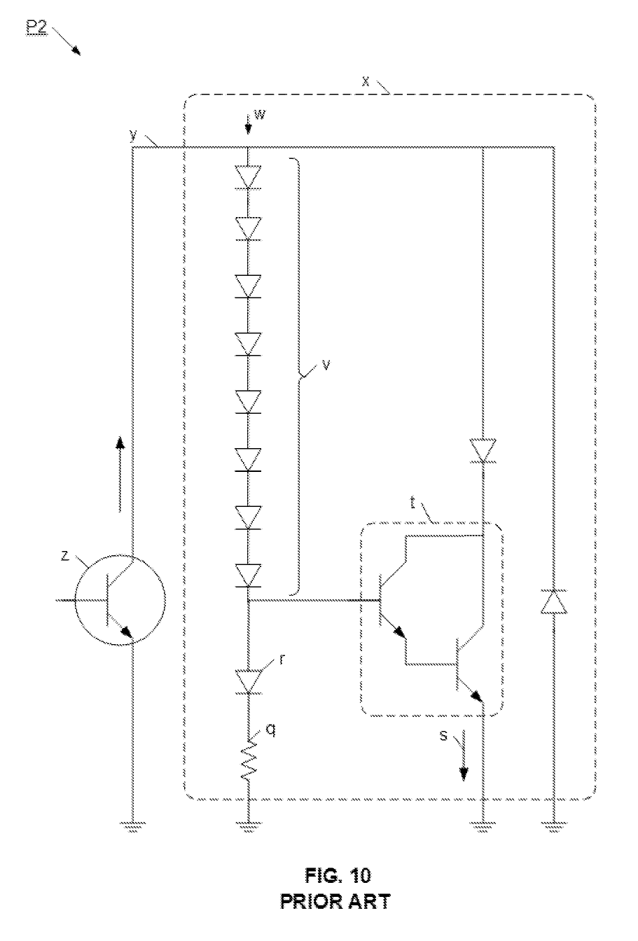

The voltage at which the ESD protection circuit activates is set by the voltage 186 required on line 167 to activate the Darlington device 170, plus the breakdown voltage 185 of device 164. Assuming that device 164 has a breakdown voltage of about 9 volts, and assuming the Darlington device activates at about 2½ volts, then the protection circuit activates when an ESD voltage larger than about 11½ volts is present at point A on the output line 159. It will be appreciated that the specific activation voltage may be adjusted according to the specific components selected for the Darlington circuit 170, by the breakdown voltage for the breakdown of diode 164, by the turn on voltage of 169, by the number of diode, by the voltage drop across 166, and by the expected operational voltage swings for the transistor 157. The ESD triggering voltage on point A or line 159 can be adjusted by adding multiple voltage drop device such as diode in path 185 (as displayed in FIG. 8).

Once the Darlington circuit 170 has drawn the ESD current away from output line 159, the voltage at point 163 will drop below the ESD trigger voltage, and diode 164 will no longer pass current. In this regard, voltage 167 will drop below the activation voltage for Darlington device 170, and the Darlington device 170 will deactivate. In this way, the ESD protection circuit 154 deactivates and the transistor 157 may continue to normal operation. A negative ESD shunt line 181 is provided to shunt any negative ESD signals received on output line 159. Since all output voltages from transistor 157 are expected to be positive, the shunt line 181 is allowed to directly shunt all negative voltage directly to ground through diode 179. As illustrated, diode 179 is reversely biased for positive signals, and it is selected as one having higher reverse breakdown voltage than the maximum RF signal swing in the normal transistor 157 operation. It would not affect 157 normal RF operation, but would be forward biased and dump ESD energy for negative ESD signals at line 159 or point A. In this way, any voltage less than about −1.2 volts will be shunted to ground.

When the Darlington device 170 is activated, it acts to immediately drain excess current from point 163. In this way, the amount of current 165 flowing through diode 164 is minimized, thereby reducing the chance that the reverse diode current could damage diode 164. Since the reverse current 165 flows for such a short time, and at such a limited value, diode 164 may operate successfully even when very large ESD voltage signals are seen initially at point A.

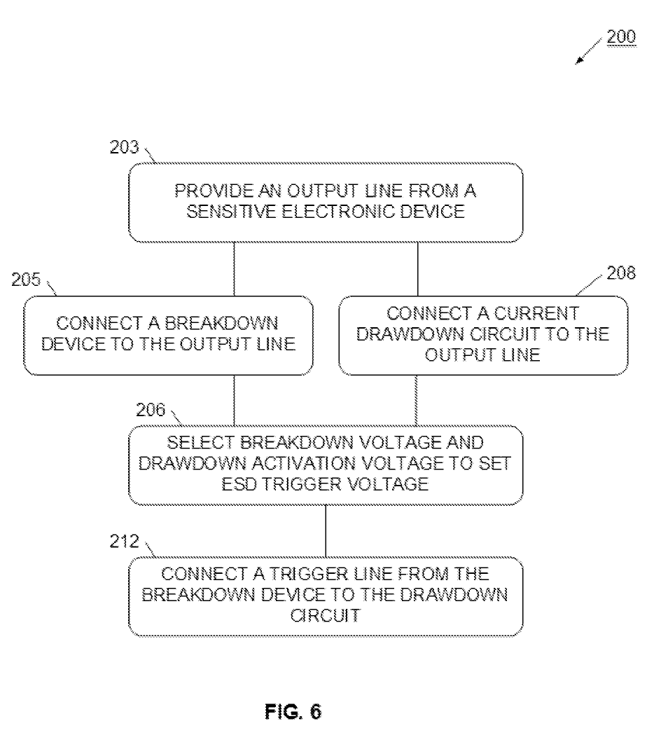

Referring now to FIG. 6, a method for making an ESD protected device is illustrated. Method 200 has a sensitive electronic device which provides an output line as shown in block 203. The sensitive electronic device may be for example, a final stage power transistor for an amplifier. In other examples, the sensitive electronic device may be a transistor, memory device, or other integrated or semiconductor device. In some cases, the sensitive electronic device may have a large operational voltage swing, which makes ESD protection somewhat more difficult. A breakdown device is connected to the output line as shown in block 205. In one example, the breakdown device is a diode or other junction device. A current drawdown circuit is also connected to the output line as shown in block 208. Normally, the drawdown circuit will exhibit very high impedance to the output line, so that the output from the sensitive electronic device may be normally used. However, the current drawdown circuit has an activation or voltage threshold that when exceeded causes the current drawdown circuit to quickly pump current from the output line to ground. In one example, the current drawdown circuit is a Darlington circuit. It will be appreciated that other current drawdown mechanisms and circuits may be used.

The voltage at which the breakdown device breaks down and the voltage at which the drawdown circuit activates cooperate to set the overall ESD trigger voltage 206. For example, the breakdown voltage may be added to the activation voltage to define the ESD trigger voltage. In a specific example, the breakdown voltage for a diode may be about 9 volts, and the activation voltage for the drawdown circuit may be about 2½ volts. Accordingly, the ESD voltage trigger voltage will be about 11½ volts. In this way, signals on the output line having voltages less than about 11½ V will not activate the ESD protection circuit, but voltages over 11½ volts will trigger the ESD protection circuit to immediately and quickly pump current from the output line. A trigger line is connected from the breakdown device to the drawdown circuit as shown in block 212.

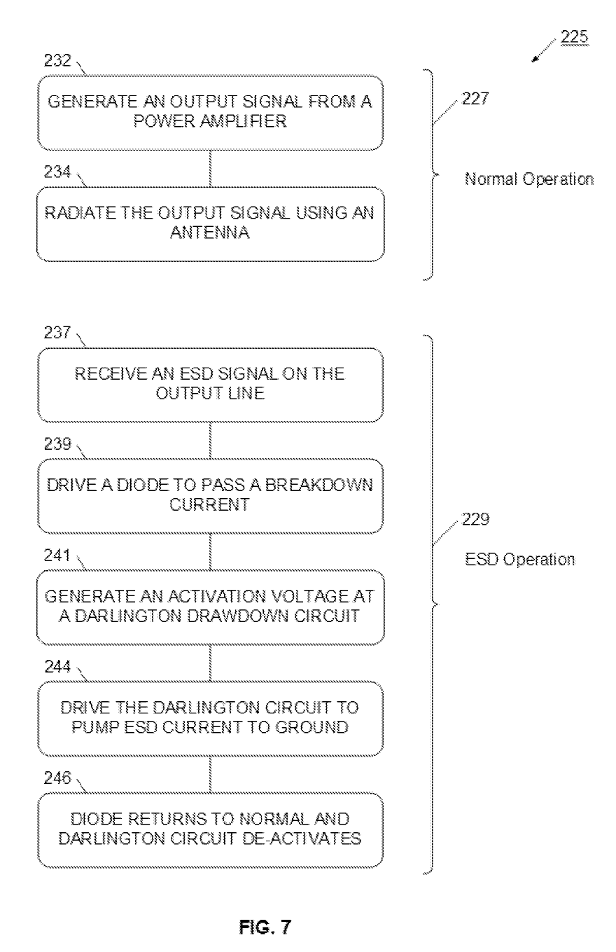

Referring now to FIG. 7, a method of using an ESD protected device is illustrated. Method 225 has a power amplifier generating output signal as shown in block 232. The output signal passes through a low impedance line and is radiated using an antenna as shown in block 234. In this way, the power amplifier operates normally 227 when no ESD condition is found. However, from time to time, an ESD event or signal may occur. In such a case, the ESD protection circuit begins an ESD operation 229. When an ESD signal is received on the output line as shown in block 237, it drives a diode to its breakdown voltage as shown in block 239. Once the diode reaches its breakdown voltage, it begins to pass current in its reverse direction. The breakdown diode may cooperate with other diodes and resistors to generate an activation voltage for activating a Darlington drawdown circuit as shown in block 241. Once the Darlington drawdown circuit activates, it acts to pump ESD current to ground as shown in block 244.

The breakdown voltage and activation voltage have been selected to provide a desirable ESD trigger voltage. Preferably, the ESD trigger voltage is higher than the normal operational voltage swing for the power amplifier, but yet is less than the damaging voltage that would damage the power amplifier. In this way, the power amplifier is allowed to operate normally until potentially damaging signals are present on the output line. Then, responsive to the damaging ESD signals, the Darlington drawdown circuit immediately pumps current away from the output line to ground, thereby protecting the power amplifier from damaging power spikes. After the Darlington circuit pumps current away from the output line, the breakdown diode returns to normal and the Darlington circuit deactivates. Accordingly, ESD operation ends and the device returns to normal operation 227. Although the circuits described thus far have focused on ESD events, it will be appreciated that the ESP protection circuit will protect against other sources of damaging power.

Referring now to FIG. 8, another ESD protected device 250 is illustrated. ESD protected device 250 is similar to ESD device 150 described with reference to FIG. 5, and therefore will not be described in detail. ESD device 250 has a sensitive electronic device 257 which drives a signal onto low impedance output line 259. The sensitive electronic device 257 has an operational output swing greater than the power amplifier discussed with reference to device 150. Accordingly, the 9 volt breakdown device for the diode would be too low, and expected output signals may activate the ESD protection circuit. To avoid such activation, additional diodes, such as diodes 285 and 286 may be used to increase the ESD trigger voltage. In this case, since each diode has a forward bias of about 1.2 volts, an additional 2.4 volts is added to the ESD trigger voltage. Assuming the breakdown voltage for the diode is still about 9 volts, and the activation voltage for the Darlington circuit 270 is still about 2½ volts, then the ESD trigger voltage will be about 13.9 volts. Preferably, the sensitive electronic device 257 has been selected such that its breakdown voltage is higher than the 14 volts breakdown voltage for the power transistor of FIG. 150. A higher breakdown voltage would provide an additional margin of safety. Although the ESD protection circuit 252 may provide protection for such a device, preferably additional safety margin would be built into the system.

The additional forward diodes 285 and 286 may also be used when a diode with desired breakdown voltage cannot be found. For example, if a 9 volts breakdown voltage is desired, but the only available diode has a breakdown voltage of about 7 volts, then the two diodes may be added in series to bring the overall trigger voltage out to its required level. In some constructions, the activation voltage for the Darlington device 270 may also be different than the typical 2 to 3 volts. In a case where the activation voltage 267 needs to be adjusted, additional diodes may be inserted as shown by diode 288. Each diode in this position would increase the activation voltage 267 by its turn-on voltage (about 1.2 volts for base-collector junction diode). It will also be appreciated that the size of the resistor may also be adjusted, as well as other circuit parameters to adjust voltage 267.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. An Electro-Static Discharge (ESD) protected device, comprising:
a sensitive electronic component having a signal line;
an ESD breakdown device connected to the signal line in a reverse bias arrangement;
a current drawdown circuit configured to selectively pump current from the signal line to ground;
an activation line connected between the ESD breakdown device and the current drawdown circuit; and
wherein the current drawdown circuit selectively pumps current responsive to an activation voltage on the activation line.

2. The ESD protected device according to claim 1, wherein the sensitive electronic device is a power transistor.

3. The ESD protected device according to claim 1, wherein the sensitive electronic device is an integrated circuit, transistor, capacitor, resistor, thin metal line, or memory device.

4. The ESD protected device according to claim 1, wherein the signal line is an output line or DC power supply line for the sensitive electronic device.

5. The ESD protected device according to claim 1, wherein the ESD breakdown device is a diode.

6. The ESD protected device according to claim 1, wherein the current drawdown circuit is a Darlington circuit.

7. The ESD protected device according to claim 6, further comprising one or more diodes between the Darlington circuit and the signal line.

8. The ESD protected device according to claim 1, wherein the current drawdown circuit comprises a high-gain amplification circuit.

9. The ESD protected device according to claim 1, wherein the current drawdown circuit comprises cascaded transistors.

10. An Electro-Static Discharge (ESD) protected device, comprising:
an electronic device having a signal line carrying signals in a voltage swing range, and an electronic device having DC power supply line, the electronic device having a damage voltage threshold;
a diode connected to the signal line in a reverse bias arrangement, and selected to have a proper breakdown voltage;
a current drawdown circuit configured to selectively pump current from the signal line to ground, the current drawdown circuit pumping current responsive to an activation voltage received on an activation line; and
activation components connected between the current drawdown circuit and ground and arranged to provide the activation voltage.

11. The ESD protected device according to claim 10, wherein the diode is connected to the activation components.

12. The ESD protected device according to claim 10, wherein the diode connects to ground through the activation components.

13. The ESD protected device according to claim 10, wherein the diode and the activation components connect to the activation line.

14. The ESD protected device according to claim 10, wherein the breakdown voltage and the activation voltage sum to form an ESD trigger voltage.

15. The ESD protected device according to claim 10, wherein the breakdown voltage and the activation voltage provide an ESD trigger voltage, and the ESD trigger voltage is more than the voltage swing range, but less than the damage voltage threshold.

16. The ESD protected device according to claim 10, wherein the current drawdown circuit is a Darlington circuit

17. The ESD protected device according to claim 10, wherein the current drawdown circuit further comprises one or more diodes.

18. The ESD protected device according to claim 10, wherein the current drawdown circuit comprises a high-gain amplification circuit having low RF loading.

19. The ESD protected device according to claim 10, wherein the current drawdown circuit comprises cascaded transistors.

20. The ESD protected device according to claim 10, wherein the electronic device is a power transistor.

21. The ESD protected device according to claim 10, wherein the electronic device is an integrated circuit, transistor, or memory device.

22. A method for protecting a sensitive electronic device from an Electro-Static Discharge (ESD) signal, comprising:
receiving the ESD signal on a line connected to the sensitive electronic device;
driving a diode to pass a breakdown current using the ESD signal;
using the breakdown current to generate an activation voltage across the activation components;
activating a current drawdown circuit with the activation voltage; and
pumping current from the line using the current drawdown circuit.

23. The method according to claim 22, wherein the using step comprises driving a forward biased diode.

24. The method according to claim 22, wherein the using step comprises driving a resistor.

25. The method according to claim 22, wherein the sensitive electronic device is a power transistor.

26. The method according to claim 22, wherein the sensitive electronic device is an integrated circuit, transistor, diode, capacitor, resistor or memory device.

27. The method according to claim 22, wherein the current drawdown circuit is a Darlington circuit.

28. The method according to claim 22, wherein the current drawdown circuit comprises a high-gain amplification circuit.

29. The method according to claim 22, wherein the current drawdown circuit comprises cascaded transistors.

30. The method according to claim 22, wherein the current drawdown circuit is used to replace multiple diodes connected in forward bias for higher turn-on voltage.

31. The method according to claim 22, wherein the reverse diode is used to replace multiple forward connected diodes to save GaAs chip area.

32. The method according to claim 22, wherein the breakdown voltage is used to replace high turn-on voltage of multiple diodes connected in forward bias.
